(19) United States
(12) Patent Application Publication
(10) Pub. No.: US 2016/0300556 A1
(43) Pub. Date: Oct. 13, 2016

(54) KEYBOARD DEVICE AND KEYBOARD INSTRUMENT

(71) Applicant: CASIO COMPUTER CO., LTD., Tokyo (JP)

(72) Inventor: Yuichi NISHIMURA, Saitama-shi (JP)

(73) Assignee: CASIO COMPUTER CO., LTD., Tokyo (JP)

(21) Appl. No.: 15/091,432

(22) Filed: Apr. 5, 2016

(30) Foreign Application Priority Data
Apr. 10, 2015 (JP) 2015-080988
Mar. 24, 2016 (JP) 2016-059459

(51) Int. Cl. G10H 1/34

(52) U.S. Cl. CPC G10H 1/346; G10H 2220/265

(57) ABSTRACT

A keyboard device includes a plurality of transmission members which are displaced in response to a depression operation on each of a plurality of keys and a plurality of hammer members each of which provides an action load to a depressed key by performing a rotating motion in response to the displacement of a transmission member corresponding to the depressed key. The weight of the transmission member is set in accordance with the formation density of a plurality of ribs formed on a transmission body section. Therefore, the weight of the transmission member set in accordance with the formation density of the ribs can be provided to the key as a static load. As a result of this structure, an initial load on a key can be optimized, and a key depressing force on the key at the time of key depression can be favorably transmitted to the hammer member.

### CROSS-REFERENCE TO RELATED APPLICATIONS

This application is based upon and claims the benefit of priority from the prior Japanese Patent Applications No. 2015-080988, filed Apr. 10, 2015 and No. 2016-059459, filed Mar. 24, 2016, the entire contents of which are incorporated herein by reference.

### BACKGROUND OF THE INVENTION

1. Field of the Invention

The present invention relates to a keyboard device for use in a keyboard instrument such as a piano, and a keyboard instrument including the keyboard device.

2. Description of the Related Art

For example, a keyboard device such as a piano is known which includes a wippen that rotates by a key depression operation, a jack that is driven in response to the rotating motion of the wippen, and a hammer member that is driven by the jack and strikes a string such that these components are provided corresponding to a plurality of keys, as described in Japanese Patent Application Laid-Open (Kokai) Publication No. 2002-258835.

This type of keyboard device is structured such that, when a key is depressed, the wippen is rotated by the depressed key, and the jack incorporated in this wippen is driven by the wippen to press up the hammer member, whereby the hammer member is rotated and strikes the string.

However, in this keyboard device, not only a repetition lever for incorporating the jack in the wippen but also a support rod for supporting this repetition lever on the wippen is required. Therefore, there is a problem in that the number of the components is increased and the structure is complicated. Moreover, in order to acquire an optimum key-touch feel, the weight of the hammer member is required to be adjusted, which makes the structure further complicated.

This key-touch feel is determined by the state of counterforce applied to a key after key depression. FIG. 13 is a graph showing the state of counterforce in a general acoustic piano. The horizontal axis represents elapsed time after key depression, and the vertical axis represents the magnitude of counterforce.

The key-touch feel significantly varies particularly depending on timing when counterforce reaches its peak after key depression (in FIG. 13, time t=b).

Because this timing when the counterforce reaches its peak is determined by various elements regarding the wippen and the hammer member such as their positional relation, structure, weight, and materials, it cannot be adjusted easily.

### SUMMARY OF THE INVENTION

The present invention is to provide a keyboard device from which a favorable key touch can be acquired, and a keyboard instrument including this keyboard device.

In accordance with one aspect of the present invention, there is provided a keyboard device comprising: a plurality of keys; and action mechanisms respectively provided corresponding to the plurality of keys, wherein each of the action mechanisms includes a transmission member which is displaced in response to a depression operation on a corresponding key of the plurality of keys, a transmission holding shaft which holds the transmission member, and a hammer member which provides an action load to the corresponding key subjected to the depression operation by being displaced in a direction in response to the displacement of the transmission member corresponding to the key subjected to the depression operation, wherein the transmission member includes a transmission body section, a transmission fitting section formed at one end of the transmission body section and mounted on the transmission holding shaft, and a barycenter position setting member formed on the transmission body section, and wherein the barycenter position setting member is set so that a key touch feeling of the depression operation is adjusted.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a planar view of a keyboard device in an embodiment where the present invention has been applied in an electronic keyboard instrument;

FIG. 2 is an enlarged sectional view of the keyboard device taken along line A-A in FIG. 1;

FIG. 3 is an enlarged sectional view of the main portion of the keyboard device depicted in FIG. 2;

FIG. 4A and FIG. 4B are diagrams showing portions of a transmission member and a transmission holding member depicted in FIG. 3, of which FIG. 4A is an enlarged planar view thereof and FIG. 4B is an enlarged sectional view of the main portion taken along line B-B in FIG. 4A:

FIG. 5A is an enlarged side view of the transmission member depicted in FIG. 3, and FIG. 5B is an enlarged sectional view thereof taken along line C-C in FIG. 5A;

FIG. 6A and FIG. 6B are diagrams showing portions of a hammer member and a hammer holding member depicted in FIG. 3, of which FIG. 6A is an enlarged planar view thereof and FIG. 6B is an enlarged sectional view of the main portion taken along line D-D in FIG. 6A;

FIG. 7A, FIG. 7B, FIG. 7C, and FIG. 7D are diagrams showing the hammer member depicted in FIG. 3, of which FIG. 7A is an enlarged side view of a hammer member for a white key, FIG. 7B is an enlarged planar view thereof, FIG. 7C is an enlarged side view of a hammer member for a black key, and FIG. 7D is an enlarged planar view thereof;

FIG. 8A, FIG. 8B, and FIG. 8C are diagrams showing an interlock control section depicted in FIG. 3, of which FIG. 8A is an enlarged sectional view of the interlock control section taken along line E-E in FIG. 3, FIG. 8B is an enlarged side view of an interlock projecting section of the interlock control section, and FIG. 8C is an exploded and enlarged side view of the interlock projecting section;

FIG. 9 is an enlarged sectional view of the main portion of the keyboard device depicted in FIG. 3, in which a key has been depressed;

FIG. 10 is an enlarged side view of a modification example of the transmission member in the keyboard device to which the present invention has been applied;

FIG. 11A and FIG. 11B are diagrams showing another modification example of the transmission member in the keyboard device to which the present invention has been applied, of which FIG. 11A is an enlarged side view thereof and FIG. 11B is an enlarged sectional view taken along line C-C in FIG. 11A;

FIG. 12A and FIG. 12B are diagrams showing still another modification example of the transmission member in the keyboard device to which the present invention has been applied, of which FIG. 12A is an enlarged side view thereof and FIG. 12B is an enlarged sectional view taken along line C-C in FIG. 12A;

FIG. 13 is a graph showing the state of counterforce in a general acoustic piano;

FIG. 14A is a diagram showing a transmission member without a fine-grid rib section, and FIG. 14B is a diagram showing the characteristic of counterforce applied to a key when the key is depressed by using this transmission member;

FIG. 15A is a diagram showing a case in which, as the transmission member depicted in FIG. 5A, ribs are provided in two cells positioned on the lower side and a cell positioned at a distance from a transmission fitting section longer than a distance from the center of the transmission member, and FIG. 15B is a diagram showing the characteristic of counterforce applied to a key when the key is depressed by using this transmission member; and

FIG. 16A is a diagram showing a structure in which rib sections are provided on the lower side of the transmission member 10 having a large-grid lattice shape and the number of ribs formed on the upper side thereof is increased to form a small-grid lattice shape, and FIG. 16B is a diagram showing the characteristic of counterforce applied to a key when the key is depressed by using this transmission member.

### DETAILED DESCRIPTION OF THE PREFERRED EMBODIMENT

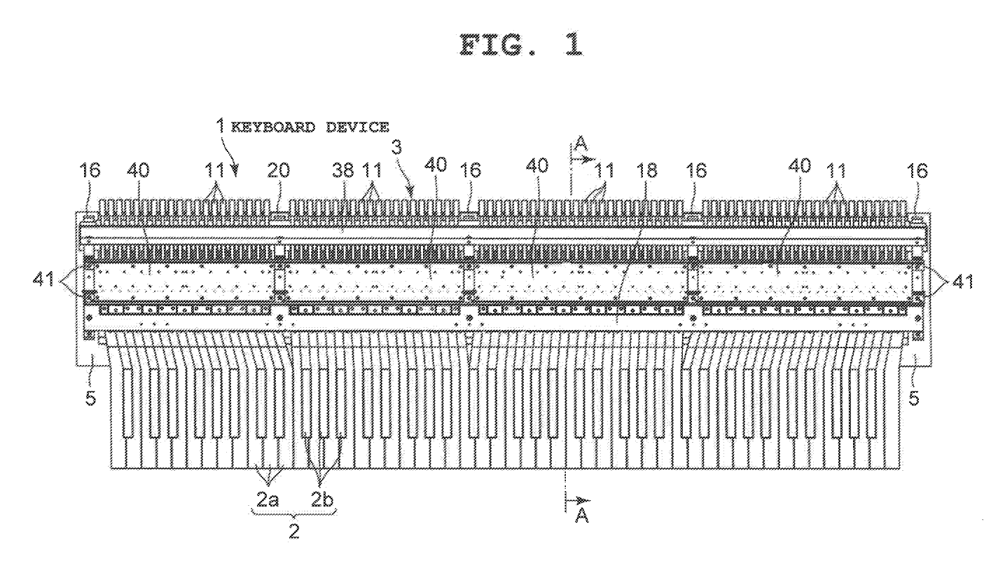

Hereafter, an embodiment in which the present invention has been applied in an electronic keyboard instrument is described with reference to FIG. 1 to FIG. 9.

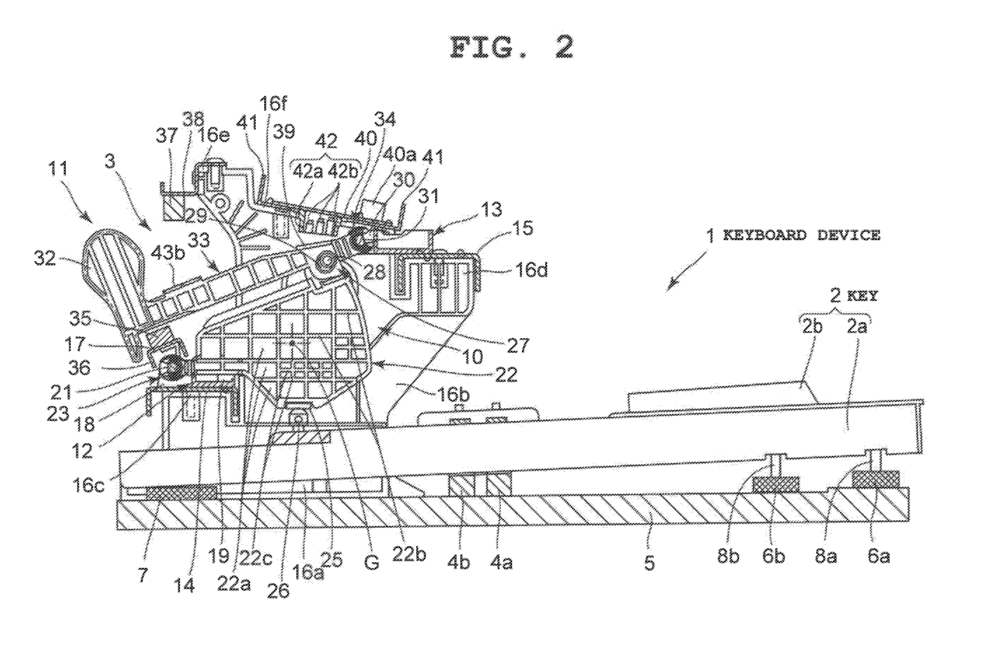

The electronic keyboard instrument includes a keyboard device 1 as depicted in FIG. 1 and FIG. 2. This keyboard device 1, which is mounted inside an instrument case (not depicted), includes a plurality of keys 2 arranged in parallel and action mechanisms 3 each of which provides an action load to a corresponding key 2 of the plurality of keys 2 in response to a key depression operation.

The plurality of keys 2 have white keys 2a and black keys 2b as depicted in FIG. 1 and FIG. 2. These white keys 2a and black keys 2b, eighty eight in total, are arranged in parallel. Each of the plurality of keys 2 is supported by balance pins 4a and 4b at a substantially intermediate portion in the front and rear direction (in FIG. 2, the lateral direction) of the key so as to be rotatable in the vertical direction and, in this state, these keys 2 are arranged in parallel on a base plate 5. That is, the white keys 2a and the black keys 2b have different lengths in the front and rear direction, and the lengths of the white keys 2a are longer than the lengths of the black keys 2b.

In addition, on the base plate 5, cushion members 6a and 6b with which the lower surface of the front end portion (in FIG. 2, the right end portion) of each key 2 separably comes in contact are provided along the array direction of the keys 2, as depicted in FIG. 2. Also, on the base plate 5, a cushion member 7 with which the lower surface of the rear end portion (in FIG. 2, a left end portion) of each key 2 separably comes in contact is provided along the array direction of the keys 2.

As a result, for the plurality of keys 2, each key stroke is set by the cushion members 6a and 6b on the front side and the cushion member 7 on the rear side, as depicted in FIG. 2. Moreover, on the base plate 5, guide pins 8a and 8b for preventing the rolling of the plurality of keys 2 in their array direction are provided upright.

The action mechanisms 3 include a plurality of transmission members 10 each of which rotates in the vertical direction in response to a key depression operation on a corresponding one of the plurality of keys 2, and a plurality of hammer members 11 each of which rotates in the vertical direction in accordance with the rotating motion of a corresponding one of the plurality of transmission members 10 and thereby provides an action load to the corresponding one of the plurality of keys 2, as depicted in FIG. 1 to FIG. 3. In this embodiment, the plurality of keys 2 are each structured to be rotated in the counterclockwise direction around the balance pins 4a and 4b by the weight of a corresponding one of the plurality of transmission members 10 and the weight of a corresponding one of the plurality of hammer members 11, and pressed up to an initial position, so that an initial load is provided thereto.

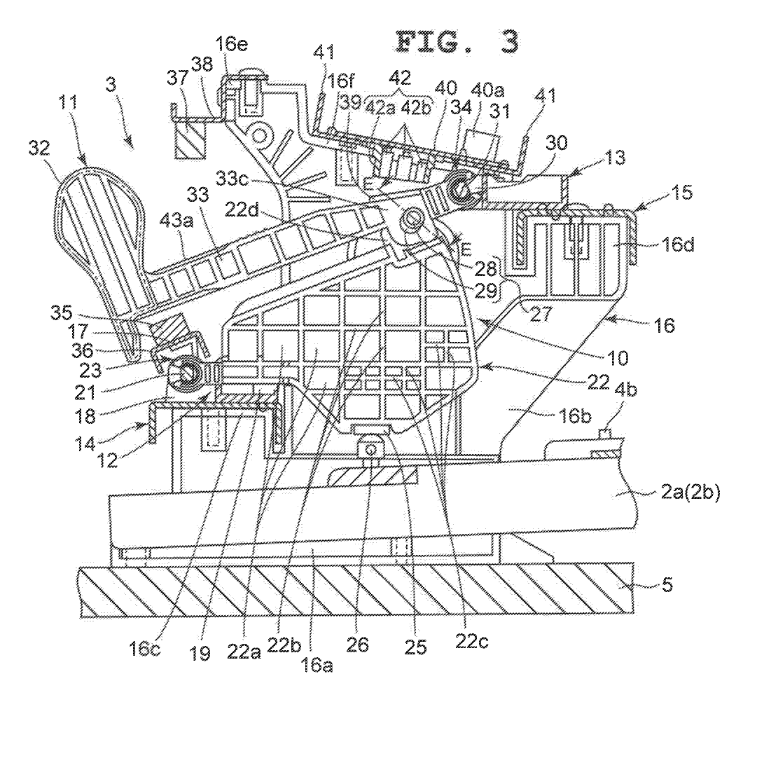

These action mechanisms 3 also include a plurality of transmission holding members 12 each of which rotatably holds a corresponding one of the plurality of transmission members 10 and a plurality of hammer holding members 13 each of which rotatably holds a corresponding one of the plurality of hammer members 11, as depicted in FIG. 2 and FIG. 3. The plurality of transmission holding members 12 are mounted on a transmission support rail 14 arranged along the array direction of the keys 2. Also, the plurality of hammer holding members 13 are mounted on a hammer support rail 15 arranged along the array direction of the keys 2. These transmission support rail 14 and hammer support rail 15 are supported by a plurality of support members 16 and arranged above the plurality of keys 2.

The plurality of support members 16 are mounted upright on the base plate 5 and positioned in a plurality of areas defined in advance over the entire length of the keys 2 in the arrangement direction. Here, the number of the arranged keys 2 is, for example, eighty eight in total. Accordingly, the plurality of support members 16 are arranged at both ends of the plurality of keys 2 in the array direction and three areas located at every twenty keys. That is, in the present embodiment, the plurality of support members 16 is arranged in five areas over the entire length of the keys 2 in the array direction.

The support members 16 are made of hard synthetic resin such as ABS (Acrylonitrile Butadiene Styrene) resin, and each of them has a mount section 16a mounted on the base plate 5 and a bridge section 16b integrally formed on the mount section 16a, as depicted in FIG. 2 and FIG. 3. By the support member mount section 16a being mounted on the base plate 5, the support member 16 is structured to be arranged between rear portions of the plurality of keys 2 with the bridge section 16b projecting above the key 2.

Here, a lower portion of the rear end of the bridge section 16b, that is, an upper portion on the rear side (in FIG. 2, an upper portion on the left) of the mount section 16a is provided with a rear-side rail support section 16c which supports the transmission support rail 14, as depicted in FIG. 2 and FIG. 3. Also, an upper portion on the front side (in FIG. 2, an upper portion on the right) of the bridge section 16b is provided with a front-side rail support section 16d which supports the hammer support rail 15. Moreover, an upper portion on the rear side (in FIG. 2, an upper portion on the left) of the bridge section 16b is provided with a stopper rail support section 16e, and an upper portion of the bridge section 16b is provided with a substrate rail support section 16f.

The transmission support rail 14 has a shape formed by both side portions of a band plate being folded downward along the longitudinal direction, and has a length corresponding to the entire length of the plurality of keys 2 in the array direction, as depicted in FIG. 2 and FIG. 3. The transmission support rail 14 is structured such that predetermined portions thereof in the array direction of the keys 2 are mounted on the rear-side rail support sections 16c of the plurality of support members 16.

On the transmission support rail 14, the plurality of transmission holding members 12 and a plurality of stopper support sections 17 are mounted along the array direction of the keys 2, as depicted in FIG. 2 and FIG. 3. Here, the plurality of stopper support sections 17 are made of metal plates, and are mounted in five areas on the transmission support rail 14 corresponding to the plurality of support members 16 with them projecting above the plurality of transmission holding members 12.

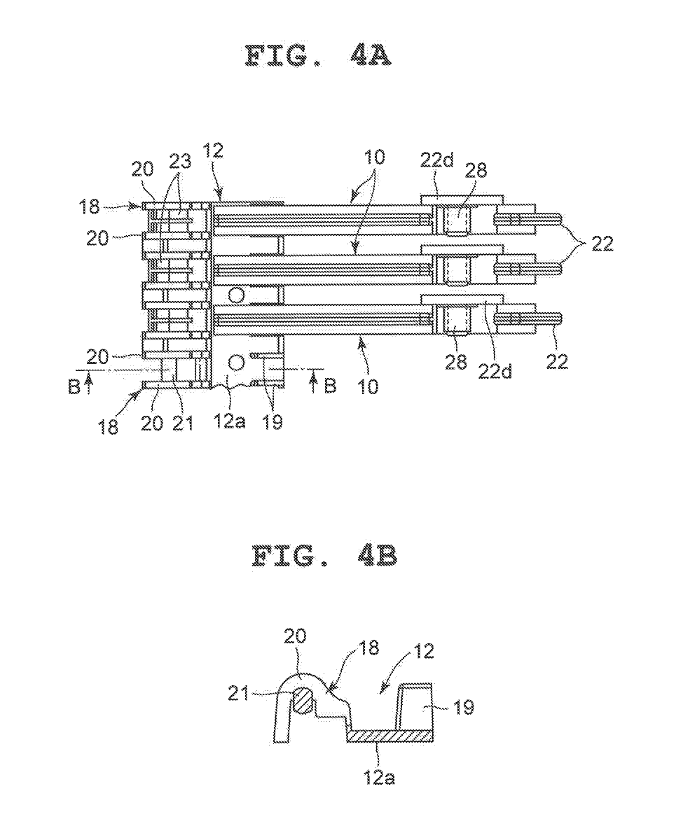

The transmission holding members 12 are made of hard synthetic resin such as ABS resin, and are integrally formed along the array direction of the keys 2 with a plurality of shaft support sections 18 on a body plate 12a respectively opposing, for example, ten keys 2, as depicted in FIG. 4A and FIG. 4B. The shaft support sections 18 are each structured to have the transmission member 10 rotatably mounted thereon so as to prevent the rolling of the transmission member 10.

That is, the shaft support section 18 has a pair of guide walls 20 and a transmission holding shaft 21 formed between the pair of guide walls 20, as depicted in FIG. 4A and FIG. 4B. The pair of guide walls 20 is formed corresponding to each of the plurality of transmission members 10 at a rear end portion (in FIG. 4A, a left end portion) on the body plate 12a of the transmission holding member 12.

This pair of guide walls 20 constitutes a guide section which rotatably guides the transmission fitting section 23 of the transmission member 10 with a later-described transmission fitting section 23 of the transmission member 10 being slidably interposed therebetween, as depicted in FIG. 4A. The transmission holding shaft 21 is formed in a substantially round-bar shape with the sides of its outer peripheral surface being cut off, and therefore has a non-circular shape in cross section, as depicted in FIG. 4B.

Also, the transmission holding member 12 has a regulating section 19 which regulates the rolling of the transmission member 10 when the keyboard device is packaged and transported, as depicted in FIG. 2 to FIG. 4B. The regulating section 19 includes a pair of regulating walls formed corresponding to each transmission member 10 on a front portion (in FIG. 4A, a right side portion) of the body plate 12a of the transmission holding member 12. This regulating section 19 rotatably guides the transmission member 10 with a lower portion on the rear side of the transmission member 10 being interposed therebetween, and also regulates the rolling of the transmission member 10 when the keyboard device is packaged and transported.

The transmission members 10 are made of hard synthetic resin such as ABS resin, and each of which has a transmission body section 22 that rotates in the vertical direction in response to a depression operation on a corresponding key 2 and thereby rotates the hammer member 11 in the vertical direction, and the transmission fitting section 23 integrally formed with the transmission body section 22 and rotatably mounted on the transmission holding shaft 21 of the transmission holding member 12, as depicted in FIG. 2 to FIG. 5B.

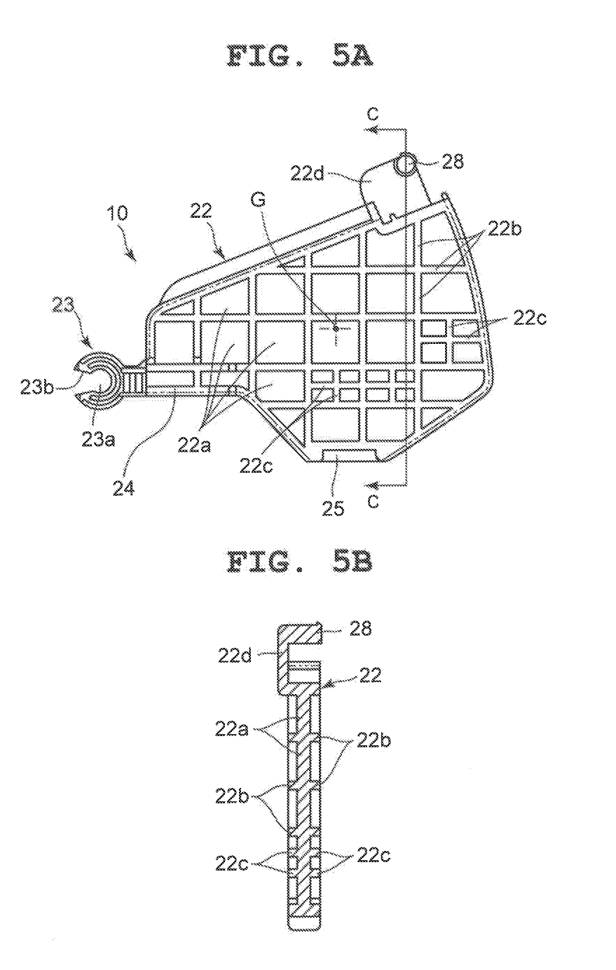

The transmission body section 22 is formed in a substantially waffle shape, as depicted in FIG. 2, FIG. 3, and FIG. 5A. That is, the transmission body section 22 has a thin vertical plate section 22a and a plurality of rib sections 22b formed in a substantially lattice shape on an outer peripheral portion and both side surfaces of the vertical plate section 22a, which are formed in a waffle shape, as depicted in FIG. 5A and FIG. 5B. Here, the transmission body section 22 is structured such that the weight and barycenter position of the transmission member 10 are adjusted by the shape and thickness of the vertical plate section 22a and the formation density of the plurality of rib sections 22b.

For example, the plurality of rib sections 22b is provided in a substantially lattice shape on both side surfaces of the vertical plate section 22a, as depicted in FIG. 5A and FIG. 5B. In this lattice shape, a plurality of finer-grid rib sections 22c is provided to part of cells in the lattice as a barycenter position setting member of the present invention, and therefore the number of ribs formed in the part of the cells is increased. That is, these fine-grid rib sections 22c are provided in two cells positioned on the lower side of the center of the vertical plate 22a and in a cell positioned at a distance from the transmission fitting section 23 longer than a distance from the center of the vertical plate section 22a.

As a result, the weight of the transmission member 10 is set by the shape and thickness of the vertical plate section 22a of the transmission body section 22 and the formation density of the plurality of rib sections 22b and 22c, as depicted in FIG. 5A. Also, in the transmission member 10, by the formation state of the plurality of rib sections 22b and 22c, that is, the formation positions of the plurality of fine-grid rib sections 22c provided to part of the plurality of rib sections 22b, a barycenter position G of the transmission member 10 is set at a position shifted from the center of the transmission body section 22.

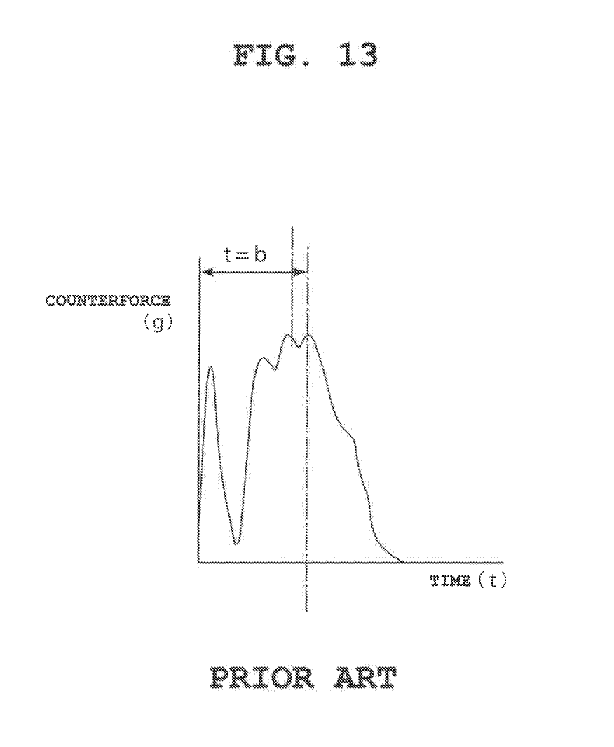

The distance between the barycenter position G and the center position of the transmission fitting section 23 is related to the counterforce characteristic depicted in the graph of FIG. 13.

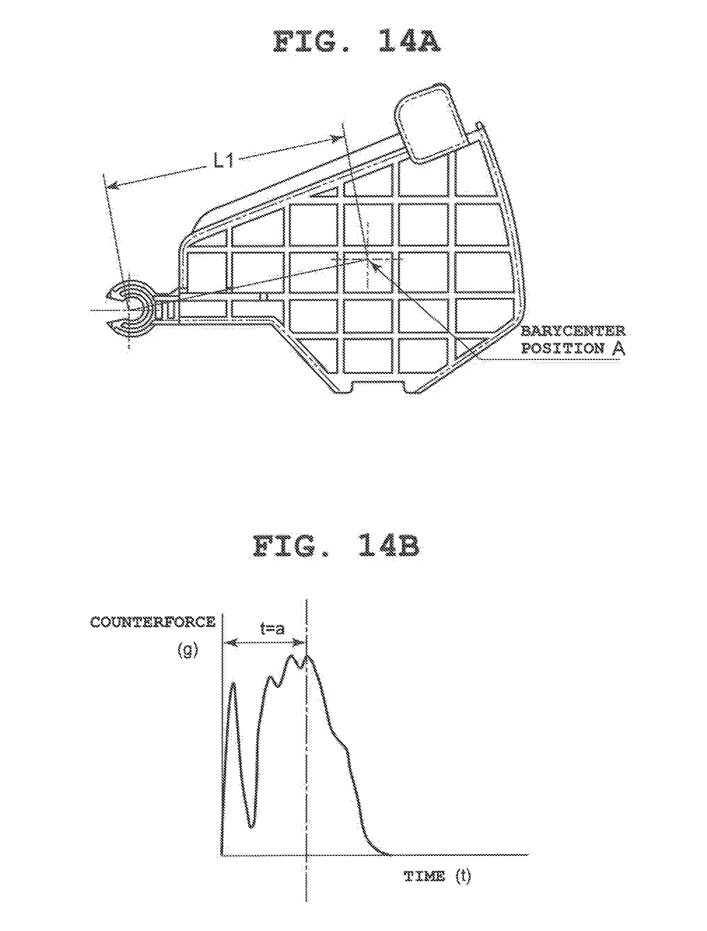

FIG. 14A to FIG. 16B are diagrams showing a relation between the barycenter position of the transmission member 10 and the counterforce characteristic.

FIG. 14A is a diagram showing a case in which the finer-grid rib sections 22c having a lattice shape are not provided as compared with the transmission member 10 depicted in FIG. 5A, and a distance between a barycenter position A and the center position of the transmission fitting section 23 is L1. The counterforce characteristic is as depicted in FIG. 14B, and the timing when the counterforce reaches its peak comes after time “a” has elapsed after a key depression operation.

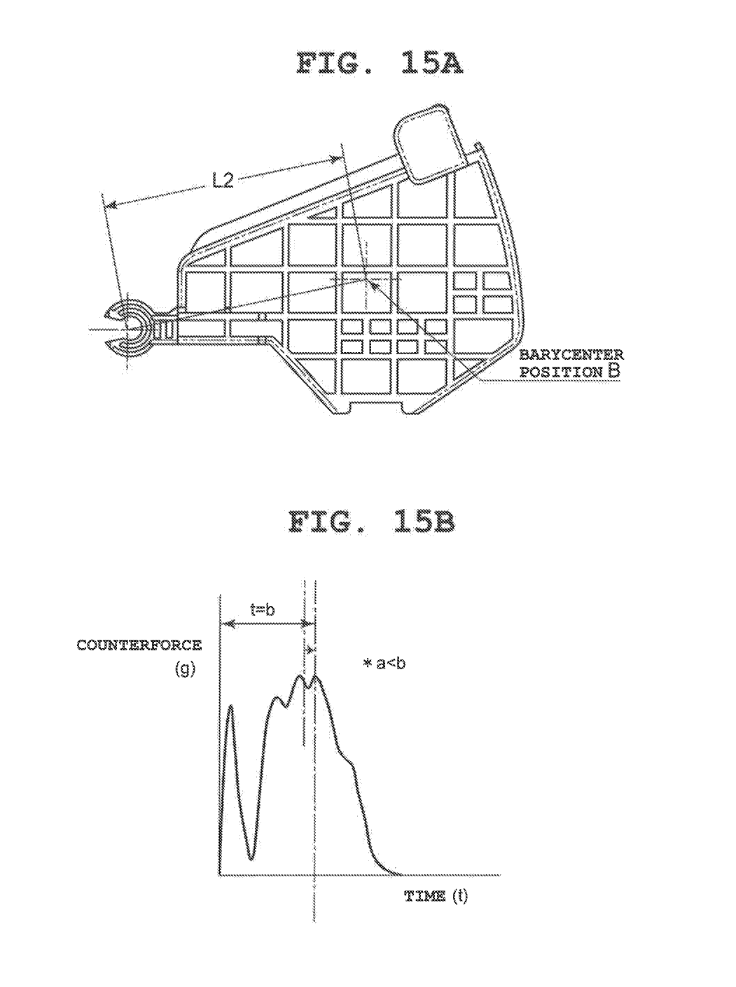

By contrast, FIG. 15A is a diagram showing a case in which, as with the transmission member 10 depicted in FIG. 5A, the rib sections 22c are provided in two cells positioned on the lower side of the center of the transmission member 10 and a cell positioned at a distance from the transmission fitting section 23 longer than the distance from the center. In this case, the barycenter position is changed to a barycenter position B, and a distance L2 between the barycenter position B and the center position of the transmission fitting section 23 is longer than the distance L1. As a result, when the transmission member 10 is rotated by key depression, the distance of the barycenter position B from the center position of the transmission fitting section 23, which is a pivot point of rotation, is longer than that in the case of FIG. 14A. Therefore, the moment of inertia is increased, and the timing (time b) when the counterforce reaches its peak can be delayed as compared with the case of FIG. 14A (b>a). In the present embodiment, by setting this time “b” equal to that in the characteristic of the acoustic piano in FIG. 13, a key touch feel identical to that of the acoustic piano can be acquired.

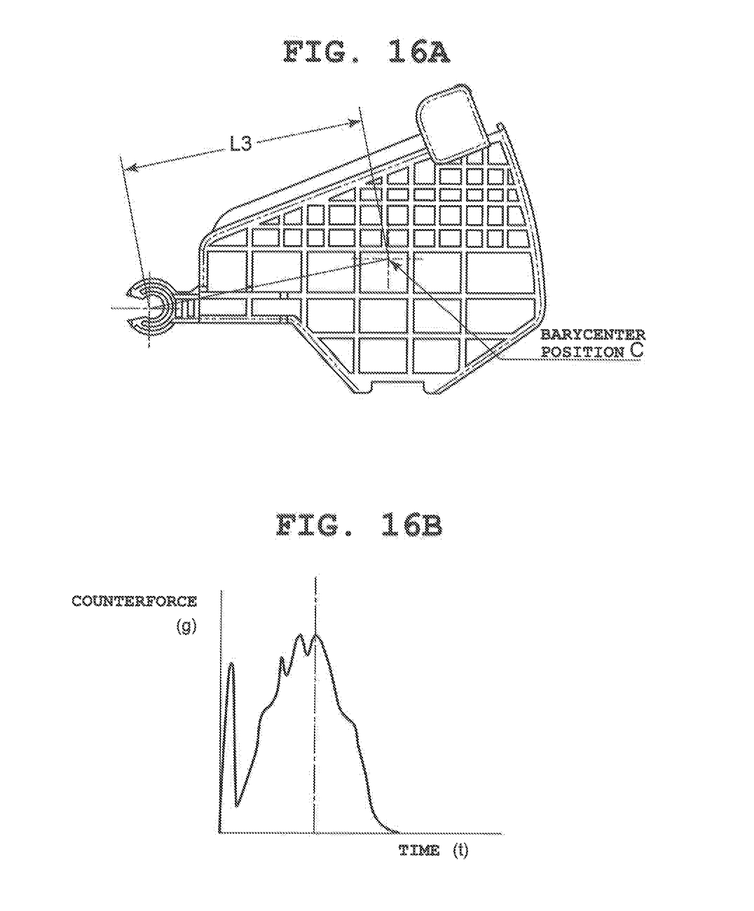

FIG. 16A is a diagram showing a structure in which rib sections are formed on the lower side of the transmission member 10 in a large-grid lattice shape and the number of ribs formed on the upper side thereof is increased to form a small-grid lattice shape. A distance L3 between a barycenter position C and the center position of the transmission fitting section 23 in this case is longer than the distances L1 and L2. As a result, when the transmission member 10 is rotated by key depression, the moment of inertia is further increased as compared with the cases of FIG. 14A and FIG. 15A, and the timing (time c) when the counterforce reaches its peak can be further delayed as compared with the cases of FIG. 14A and FIG. 15A (c>b>a).

As described above, in the present embodiment, the barycenter position of the transmission member 10 can be changed in accordance with the number of ribs formed on the transmission member 10 and the positions of the ribs formed thereon. As a result of this structure, the characteristic of counterforce applied to a key by key depression can be changed, and a more favorable key-touch feel can be acquired.

Also, in the transmission member 10, the rigidity is ensured by the plurality of rib sections 22b and 22c even though the thickness of the vertical plate section 22a of the transmission body section 22 is thinly formed. In addition, the transmission member 10 is structured such that, when it is to be formed of synthetic resin, the occurrence of a shrink is prevented by the plurality of rib sections 22b and 22c.

The transmission fitting section 23 is formed in an inverted C shape as a whole, and projects rearward at a rear end portion of the transmission body section 22, as depicted in FIG. 2. FIG. 3, and FIG. 5A. That is, the transmission fitting section 23 is formed having a thickness in the array direction of the keys 2 substantially equal to a length between the paired guide walls 20 of the shaft support section 18, and slidably inserted between the paired guide walls 20, as depicted in FIG. 4A.

Also, the transmission fitting section 23 is structured to have a fitting hole 23a provided in the center thereof, in which the transmission holding shaft 21 of the transmission holding member 12 fits, as depicted in FIG. 5A. At a portion around fitting hole 23a, that is, at a rear portion around the fitting hole 23a, an insertion port 23b is formed into which the transmission holding shaft 21 is removably inserted. By the transmission holding shaft 21 being inserted into the fitting hole 23a through the insertion port 23b, the transmission fitting section 23 is rotatably mounted on the transmission holding shaft 21.

Here, the transmission fitting section 23 is structured such that, when the transmission holding shaft 21 is to be inserted into the fitting hole 23a through the insertion port 23b, the transmission fitting section 23 stands the transmission member 10 upright above the transmission holding shaft 21 so that the insertion port 23b corresponds to a portion of the transmission holding shaft 21 where both sides have been cut off, and then the insertion port 23b is slightly widened by the transmission holding shaft 21 when the transmission holding shaft 21 is pressed into the insertion port 23b, whereby the transmission holding shaft 21 is inserted and fitted into the fitting hole 23a, as depicted in FIG. 5A.

At a lower portion on the rear side of the transmission body section 22 of the transmission member 10, a thin engaging section 24 that is regulated by the regulating section 19 of the transmission holding member 12 is provided, as depicted in FIG. 2, FIG. 3, and FIG. 5A. The side surfaces of this engaging section 24 at the lower portion on the rear side of the transmission body section 22 have been cut off, as depicted in FIG. 5A.

Accordingly, the engaging section 24 has a thickness substantially equal to a length between the pair of regulating walls of the regulating section 19, as depicted in FIG. 5A. As a result, the engaging section 24 is structured to rotatably guide the transmission member 10 by being inserted between the pair of regulating walls of the regulating section 19 and also regulate the rolling of the transmission member 10 when the keyboard device is packaged and transported.

Also, the transmission body section 22 of the transmission member 10 is formed such that its lower portion projects toward the upper surface of the key 2, as depicted in FIG. 2, FIG. 3, FIG. 4A, and FIG. 5A. At a lower end portion of the transmission body section 22, a transmission felt 25 is provided. The transmission felt 25 is structured to allow a capstan 26 provided on an upper portion on the rear side of the key 2 to come in contact with the transmission felt 25 from below.

As a result, the transmission member 10 is structured to be pressed up by the capstan 26 of the key 2 coming in contact with the transmission felt 25 from below when the key 2 is depressed, and thereby rotate around the transmission holding shaft 21 in the counterclockwise direction, as depicted in FIG. 2 and FIG. 3. Also, the transmission body section 22 of the transmission member 10 is formed such that its upper portion at the front end is higher than its upper portion at the rear end, so that its upper side portion is slanted downward to the rear portion (in FIG. 2, downward to the left).

On an upper portion at the front end of the transmission body section 22, a support section 22d is provided projecting upward, as depicted in FIG. 2, FIG. 5A, and FIG. 5B. That is, the support section 22c is structured to move in the vertical direction along a side surface of the hammer member 11 described below without coming in contact with the hammer member 11. Also, on a side surface of the support section 22c, an interlock projecting section 28 of an interlock control section 27 described below is provided.

On the other hand, as with the transmission support rail 14, the hammer support rail 15 has a shape where both side portions of a band plate have been folded downward along the longitudinal direction and has a length corresponding to the entire length of the plurality of keys 2 in the array direction, as depicted in FIG. 1 to FIG. 3. This hammer support rail 15 is structured such that predetermined portions thereof in the array direction of the keys 2 are mounted on the front-side rail support sections 16d of the plurality of support members 16. On the hammer support rail 15, the plurality of hammer holding members 13 are mounted along the array direction of the keys 2.

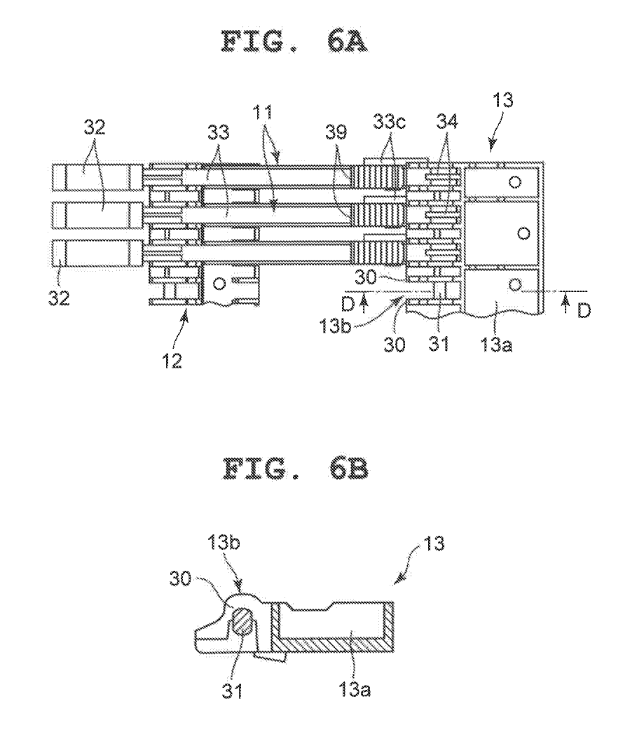

These hammer holding members 13 are made of hard synthetic resin such as ABS resin, and integrally formed along the array direction of the keys 2 with a shaft support section 13b being provided to a lower end portion of a rail-shaped body plate 13a whose upper portion is open and being opposed to each of, for example, ten keys 2, as depicted in FIG. 6A and FIG. 6B. The shaft support sections 13b are each structured to have the hammer member 11 rotatably mounted thereon so as to prevent the rolling of the hammer member 11.

That is, the shaft support section 13b has a pair of guide walls 30 and a hammer holding shaft 31 formed between the paired guide walls 30, as depicted in FIG. 2, FIG. 3, FIG. 6A, and FIG. 6B. This pair of guide walls 30 is formed on a rear end portion (in FIG. 6B, a left end portion) of the body plate 13a, corresponding to each of the plurality of hammer members 11.

Also, this pair of guide walls 30 constitutes a guide section that rotatably guides the hammer fitting section 34 of the hammer member 11 with a hammer fitting section 34 of the hammer member 11 being interposed therebetween, as depicted in FIG. 6A and FIG. 6B. The hammer holding shaft 31 is formed in a substantially round-bar shape with both sides of its outer peripheral surface being cut off as with the transmission holding shaft 21, and therefore has a non-circular shape in cross section, as depicted in FIG. 6B.

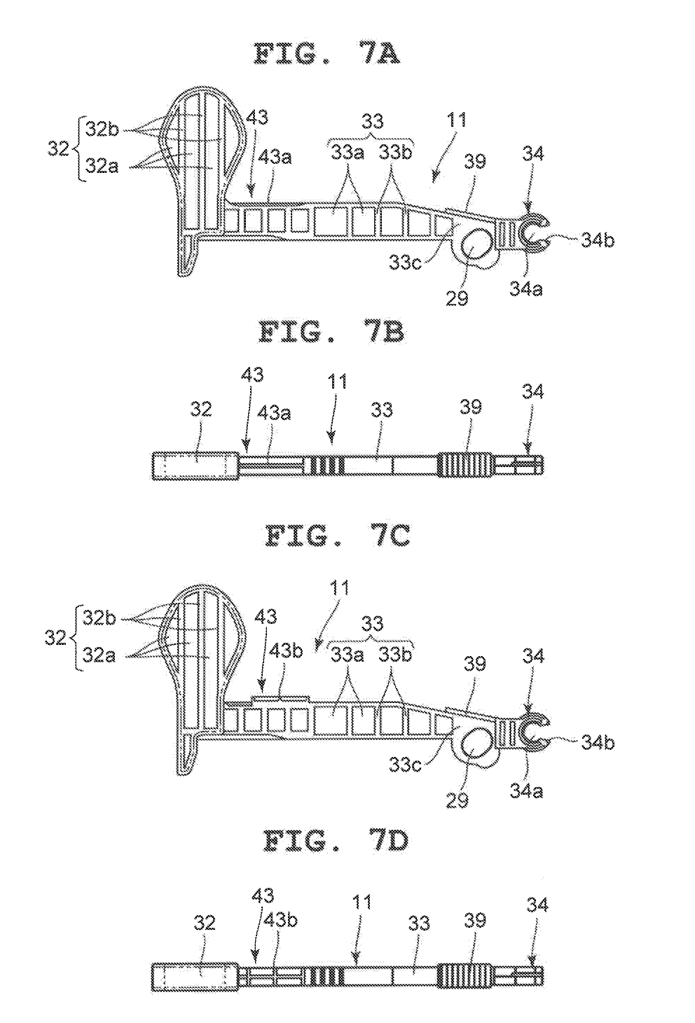

The hammer member 11 is made of hard synthetic resin such as ABS resin, and has a hammer section 32 and a hammer arm 33, which are formed integrally, as depicted in FIG. 6A, FIG. 7A, FIG. 7B, FIG. 7C and FIG. 7D. Here, the structure of the hammer member 11 for each white key 2a of the keys 2 and the structure of the hammer member 11 for each black key 2b are partially different, as depicted in FIG. 7A to FIG. 7D. That is, their stopper contact sections 43a and 43b described later, each of which comes in contact with an upper-limit stopper 37, are different from each other.

The hammer section 32 is structured to have a scoop-shaped vertical plate section 32a and a plurality of rib sections 32b formed on its outer peripheral portion and both side surfaces, as depicted in FIG. 6A, FIG. 7A, FIG. 7B, FIG. 7C and FIG. 7D. This hammer section 32 is structured such that the weight of the hammer member 11 is adjusted by the shape of the scoop-shaped vertical plate section 32a and the formation density of the plurality of rib sections 32b.

The hammer arm 33 is structured to have a lateral plate section 33a whose length in the front and rear direction is substantially equal to that of the transmission member 10 and rib sections 33b formed on its outer peripheral portion and both side surfaces, as depicted in FIG. 7A to FIG. 7D. At a front end portion (in FIG. 7A to FIG. 7D, a right end portion) of the hammer arm 33, the hammer fitting section 34 is formed, which is rotatably mounted on a hammer holding member 13.

As with the transmission fitting section 23, the hammer fitting section 34 is formed in an inverted C shape as a whole, and projects frontward at a front end portion of the hammer arm 33, as depicted in FIG. 7A to FIG. 7D. The hammer fitting section 34 is formed such that its thickness in the array direction of the keys 2 is substantially equal to a length between the paired guide walls 30, and slidably inserted between the paired guide walls 30, as depicted in FIG. 6A.

Also, the hammer fitting section 34 is structured to have a fitting hole 34a provided in its center as depicted in FIG. 7A and FIG. 7C, into which the hammer holding shaft 31 of the hammer holding member 13 is fitted. At a portion around the fitting hole 34a, that is, at a front portion around the fitting hole 34a, an insertion port 34b is formed into which the hammer holding shaft 31 is removably inserted. By the hammer holding shaft 31 being inserted into the fitting hole 34a through the insertion port 34b, the hammer fitting section 34 is rotatably mounted on the hammer holding shaft 31.

Here, the hammer fitting section 34 is structured such that, when the hammer holding shaft 31 is to be inserted into the fitting hole 34a through the insertion port 34b, the hammer fitting section 34 slants the hammer holding member 13 downward to the rear (in FIG. 7A and FIG. 7B, to the right) so that the insertion port 34b corresponds to a portion of the hammer holding shaft 31 where both sides have been cut off, and then the insertion port 34b is slightly widened by the hammer holding shaft 31 when the hammer holding shaft 31 is pressed into the insertion port 34b, whereby the hammer holding shaft 31 is inserted and fitted into the fitting hole 34a, as depicted in FIG. 7A and FIG. 7B.

That is, the hammer holding member 13 is structured such that, because it has been coupled to the transmission member 10 by the interlock control section 27 as depicted in FIG. 3 before the hammer member 11 is mounted, it is slanted downward to the rear so that the insertion port 34b of the hammer fitting section 34 corresponds to the hammer holding shaft 31 in FIG. 7, and then the hammer holding shaft 31 is mounted on the hammer support rail 15 after being inserted and fitted into the fitting hole 34a.

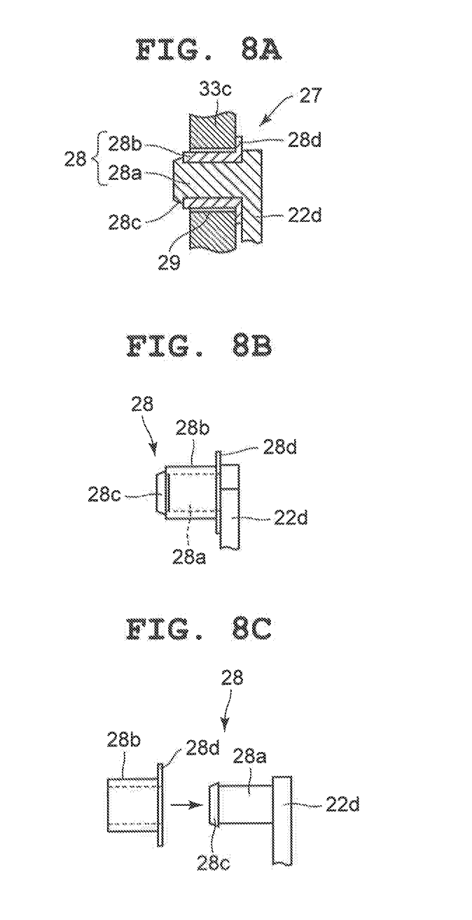

Also, on a lower portion at the front end of the hammer arm 33, a mount section 33c is provided projecting downward, as depicted in FIG. 3 and FIG. 8A. That is, the mount section 33c is structured to oppose a side surface of the support section 22d of the transmission member 10 and, in this state, move in the vertical direction along the side surface of the support section 22d. Also, the mount section 33c is provided with a guide hole 29 for guiding an interlock projecting section 28 of the interlock control section 27 described later.

Also, the hammer arm 33 is structured such that a lower portion of its rear end comes in contact with a lower-limit stopper 35 from above and thereby is regulated at a lower-limit position that is an initial position, as depicted in FIG. 2 and FIG. 3. That is, the lower-limit stopper 35 is mounted on a lower-limit stopper rail 36 supported by a plurality of stopper support sections 17 provided on the transmission support rail 14. As a result, the hammer member 11 is structured to be positionally regulated at the initial position with it being slanted downward to the rear, by the lower portion at the rear end of the hammer arm 33 coming in contact with the lower-limit stopper 35 from above.

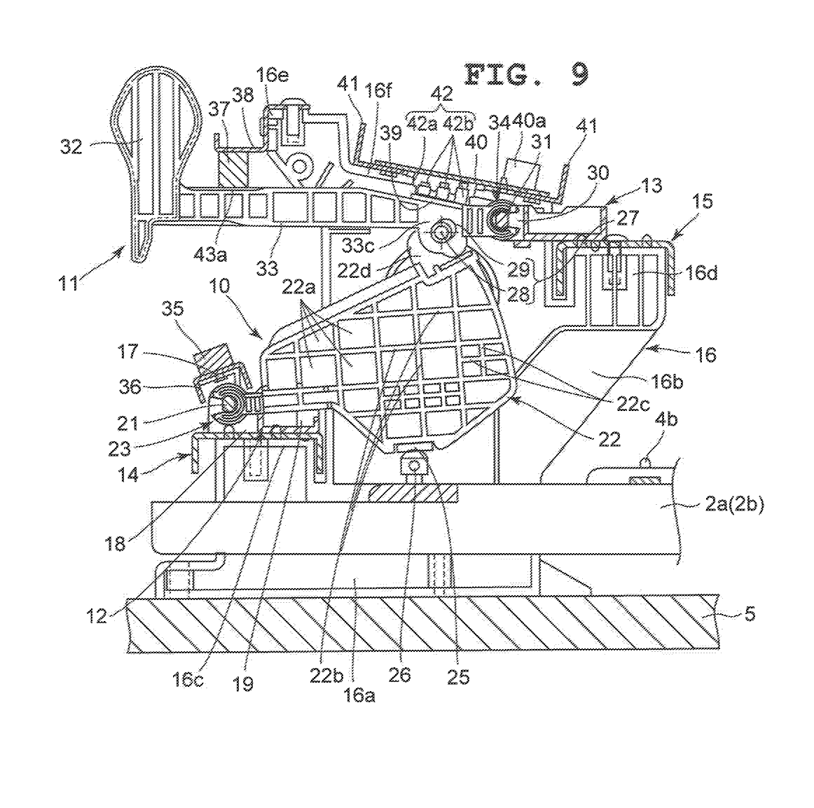

Moreover, the hammer arm 33 is structured such that each of the white-key stopper contact section 43a and the black-key stopper contact section 43b provided at its upper portion at the rear end comes in contact with the upper-limit stopper 37 from below, whereby the upper-limit position of the hammer arm 33 is regulated, as depicted in FIG. 7A, FIG. 7B, FIG. 7C, FIG. 7D, and FIG. 9. That is, the white keys 2a and the black keys 2b have different lengths in the front and rear direction, and the lengths of the white keys 2a are longer than the lengths of the black keys 2b.

Accordingly, each key stroke of the white keys 2a and the black keys 2b are adjusted by the cushion members 6a and 6b on the front side and the cushion member 7 on the rear side, and the length for a white key 2a to press up the transmission member 10 and the length for a black key 2b to press up the transmission member 10 are different from each other. That is, the amount of rotation (that is, rotation angle) of the hammer member 11 corresponding to the white key 2a when rotating around the hammer holding shaft 31 of the hammer holding member 13 is smaller than the amount of rotation (that is, rotation angle) of the hammer member 11 corresponding to the black key 2b.

Accordingly, in order to bring the hammer member 11 corresponding to the white key 2a and the hammer member 11 corresponding to the black key 2b into contact with the upper-limit stopper 37 with the same amount of rotation (that is, at the same rotation angle), it is required to adjust the height of projection of the white-key stopper contact section 43a and the height of projection of the black-key stopper contact section 43b. Therefore, the white-key stopper contact section 43a is formed at a height substantially equal to the upper surface of the hammer arm 33. Also, the black-key stopper contact section 43b is formed projecting from the upper surface of the hammer arm 33.

Here, the upper-limit stopper 37 is mounted on the lower surface of an upper-limit stopper rail 38 supported by each stopper rail support section 16e of the plurality of support members 16, as depicted in FIG. 9. As a result, the hammer member 11 is structured such that, when the hammer arm 33 is rotated around the hammer holding shaft 31 of the hammer holding member 13 in the clockwise direction, the upper portion at the rear end of the hammer arm 33 comes in contact with the upper-limit stopper 37 from below, whereby the upper-limit position of the hammer member 11 is regulated.

Also, at an upper portion at the front end of the hammer arm 33, a switch pressing section 39 is formed, as depicted in FIG. 2 and FIG. 9. In an area above this switch pressing section 39 of the hammer arm 33, a switch substrate 40 is arranged by a pair of substrate support rails 41. These substrate support rails 41 are long plates each formed in an L shape in cross section, and have a length corresponding to the entire length of the keys 2 in the array direction.

These substrate support rails 41 are mounted such that their horizontal portions are away from each other by a predetermined space on the substrate support section 16f of each of the plurality of support members 16, as depicted in FIG. 1 to FIG. 3. The switch substrate 40 is divided into a plurality of portions, as depicted in FIG. 1. In the present embodiment, the switch substrate 40 is divided into four portions each having a length corresponding to twenty keys 2, and mounted on the pair of substrate support rails 41.

On the lower surface of each of the switch substrates 40, a rubber switch 42 is provided, as depicted in FIG. 2 and FIG. 9. The rubber switch 42 has an inverted-dome-shaped bulging section 42a formed on a rubber sheet elongated in the array direction of the keys 2 in a manner to correspond to each of the plurality of hammer arms 33. Inside the bulging section 42a, a plurality of movable contacts 42b that separably come in contact with a plurality of fixed contacts (not depicted) provided on the lower surface of the switch substrate 40 are provided along the front and rear direction of the hammer arm 33.

As a result, the rubber switch 42 is structured such that, when the hammer member 11 rotates around the hammer holding shaft 31 of the hammer holding member 13 in the clockwise direction and is pressed from below by the switch pressing section 39 of the hammer arm 33, the inverted-dome-shaped bulging section 42a is elastically deformed, and the plurality of movable contacts 42b sequentially come in contact with the plurality of fixed contacts with time, whereby a switch signal according to the strength of the key depression operation on the key 2 is outputted. This switch signal is then supplied to a sound source section 40a, and a musical sound in accordance with the key depression strength on the key 2 is generated, as depicted in FIG. 9.

The interlock control section 27 has the interlock projecting section 28 provided to the support section 22d of the transmission member 10 and the guide hole 29 provided to the mount section 33c of the hammer member 11 for guiding the interlock projecting section 28, as depicted in FIG. 2 and FIG. 3. As a result, the interlock control section 27 is structured to control the rotating motion of the hammer member 11 in accordance with the rotating motion of the transmission member 10 corresponding to the key 2 subjected to a key depression operation by a relative motion of the interlock projecting section 28 with respect to the guide hole 29.

That is, the interlock projecting section 28 of the interlock control section 27 includes a rod-shaped projection body 28a and a cylindrical shock-absorbing section 28b provided on the outer periphery of the projection body 28b, as depicted in FIG. 8A to FIG. 8C. The projection body 28a is formed in a round-bar shape, as depicted in FIG. 8A to FIG. 8C.

This projection body 28a is integrally formed on an upper portion at the front end of the support section 22d provided to the transmission body section 22 of the transmission member 10 such that it projects toward the array direction of the keys 2, and movably inserted into the guide hole 29 provided in the mount section 33c of the hammer member 11, as depicted in FIG. 8A to FIG. 8C. Also, the projection body 28a has a hook portion 28c annularly formed on the outer perimeter of its tip.

The shock-absorbing section 28b is made of synthetic resin with elasticity such as urethane resin or silicone resin, and has a substantially cylindrical shape, as depicted in FIG. 8A to FIG. 8C. This shock-absorbing section 28b is formed such that its inner diameter is substantially equal to that of the projection body 28a and its length in the axial direction is equal to the length of the projection body 28a in the axial direction, that is, a length between the support section 22d and the hook section 28c.

At one end portion of the shock-absorbing section 28b, a sliding projection 28d which comes in contact with the support section 22d is formed in a flange shape, as depicted in FIG. 8A to FIG. 8C. As a result, the shock-absorbing section 28b is structured such that, when the shock-absorbing section 28b is mounted on the outer periphery of the projection body 28a, the flange-shaped sliding projection 28d comes in contact with the support section 22d and an end portion on the opposite side comes in contact with the hook section 28c of the projection body 28a, whereby the shock-absorbing section 28b is mounted on the projection body 28a with it being interposed between the support section 22c and the hook section 28c.

On the other hand, the guide hole 29 of the interlock control section 27 is a long hole into which the interlock projecting section 28 is movably inserted, and provided in the mount section 33c provided on a lower portion at the front end of the hammer arm 33 of the hammer member 11, as depicted in FIG. 3, FIG. 8A, and FIG. 9. The guide hole 29 is a long hole elongated along a relative motion path (that is, moving path) of the interlock projecting section 28 when the transmission member 10 performs a rotating motion around the transmission holding shaft 21 and the hammer member 11 performs a rotating motion around the hammer holding shaft 31.

That is, the guide hole 29 is provided such that its center line in the longitudinal direction is slanted downward to the rear (in FIG. 3, downward to the left), as depicted in FIG. 3, FIG. 8A, and FIG. 9. Also, the guide hole 29 is formed such that its length (hole width) in a direction orthogonal to the longitudinal direction is substantially equal to the outer diameter of the interlock projecting section 28, that is, the outer diameter of the shock-absorbing section 28b, and its length in the longitudinal direction is substantially one and a half or two times as long as the outer diameter of the interlock projecting section 28.

Here, the guide hole 29 is structured such that, when it moves with the interlock projecting section 28 being inserted thereinto, the shock-absorbing section 28b of the interlock projecting section 28 moves while elastically coming in contact with the inner peripheral surface of the guide hole 29, and a sliding projection 29d of the shock-absorbing section 28b slides while elastically coming in contact with a side edge portion of the guide hole 29, that is, the side surface of the mount section 33c of the hammer member 11, whereby the mount section 33c of the hammer member 11 is prevented from directly coming in contact with the support section 22d of the transmission member 10, as depicted in FIG. 3, FIG. 8A, and FIG. 9.

Thus, the interlock control section 27 is structured such that, when the transmission member 10 corresponding to a key 2 subjected to a key depression operation makes a rotating motion and the hammer member 11 makes a rotating motion along with this rotating motion of the transmission member 10, the rotating motion of the hammer member 11 is controlled by a relative motion of the interlock projecting section 28 with respect to the guide hole 29, as depicted in FIG. 3 and FIG. 9.

That is, the interlock control section 27 is structured such that, when the key 2 is subjected to a key depression operation and the transmission member 10 rotates around the transmission holding shaft 21 in the counterclockwise direction, the interlock projecting section 28 comes in contact with the upper portion at the front end of the guide hole 29 in response to the rotation of the transmission member 10 and presses up the upper portion at the front end of the guide hole 29, whereby the hammer member 11 is rotated around the hammer holding shaft 31 in the clockwise direction, as depicted in FIG. 3.

Also, this interlock control section 27 is structured such that, when the hammer member 11 is pressed upward, the interlock projecting section 28 becomes movable along the guide hole 29, whereby the transmission member 10 and the hammer member 11 can make a rotating motion in conjunction with each other regardless of whether or not the rotation speed of the transmission member 10 and the rotation speed of the hammer member 11 are the same, as depicted in FIG. 9.

Moreover, this interlock control section 27 is structured such that, when the key 2 subjected to a key depression operation is to return to the initial position, since the interlock projecting section 28 is in a state of being relatively movable with respect to the guide hole 29, the transmission member 10 rotates around the transmission holding shaft 21 in the clockwise direction by its self weight, and the hammer member 11 rotates around the hammer holding shaft 31 in the counterclockwise direction by its self weight, as depicted in FIG. 9.

Furthermore, the interlock control section 27 is structured such that, when the transmission member 10 and the hammer member 11 return to their initial positions, the interlock projecting section 28 moves toward the upper portion at the front end of the guide hole 29, whereby the interlock projecting section 28 comes in contact with or approaches the upper portion at the front end of the guide hole 29, as depicted in FIG. 3.

Next, the operation of the above-described keyboard device 1 of the electronic keyboard instrument is described.

In the keyboard device 1, in an initial state in which no key depression operation has been performed on the keys 2, the transmission member 10 rotates by its self weight around the transmission holding shaft 21 of the transmission holding section 12 in the clockwise direction, and the transmission felt 25 provided on the lower surface of the transmission body section 22 comes in contact with the capstan 26 of the corresponding key 2 from above.

Here, the weight of the transmission member 10, that is, the weight set by the shape and thickness of the vertical plate section 22a of the transmission body section 22 and the formation density of the plurality of rib sections 22b and 22c is applied to the capstan 26 of the key 2 from above. As a result, the key 2 is pressed by the transmission member 10 to rotate around the balance pins 4a and 4b in the counterclockwise direction, and the rear end of the key 2 comes in contact with the cushion members 6a and 6b to regulate the key 2 at its initial position and to regulate the transmission member 10 at its initial position.

Also, here, the hammer member 11 rotates by its self weight around the hammer holding shaft 31 of the hammer holding member 13 in the counterclockwise direction, whereby the hammer arm 33 comes in contact with the lower-limit stopper 36 and is positionally regulated at a lower-limit position. In this state, the switch pressing section 39 of the hammer member 11 has been arranged at a position below and away from the rubber switch 42 of the switch substrate 40. As a result, the rubber switch 42 is in a free state with its bulging section 42a being bulged, and also in an OFF state by the plurality of movable contacts 42b being away from fixed contacts (not depicted).

Next, a case is described in which the key 2 in the above-described state is depressed for musical performance.

In this case, when the key 2 is depressed, the key 2 rotates around the balance pins 4a and 4b in the clockwise direction in FIG. 3, and the capstan 26 of the key 2 presses up the transmission member 10. Here, the weight of the transmission member 10 set by the shape and thickness of the vertical plate section 22a of the transmission body section 22 and the formation density of the plurality of rib sections 22b and 22c is provided to the key 2 as an initial load.

As a result, the transmission member 10 rotates against its self weight around the transmission holding shaft 21 of the transmission holding member 12 in the counterclockwise direction in FIG. 3. Then, the rotating motion of the transmission member 10 is transmitted by the interlock control section 27 to the hammer member 11, and the hammer member 11 is pressed up against its self weight. That is, when the transmission member 10 rotates in the counterclockwise direction in FIG. 3, the interlock projecting section 28 comes in contact with the upper portion at the front end of the guide hole 29 in response to the rotation of the transmission member 10 and presses up the upper portion at the front end of the guide hole 29.

As a result, the hammer member 11 rotates around the hammer holding shaft 31 of the hammer holding member 13 in the clockwise direction in FIG. 3, and thereby provides an action load to the key 2. That is, when the hammer member 11 rotates around the hammer holding shaft 31 in the clockwise direction in FIG. 3, an action load is provided to the key 2 by the moment of inertia of the hammer member 11. Here, the hammer arm 33 has been formed such that its length in the front and rear direction of the key 2 is substantially equal to the length of the transmission member 10 and has the hammer section 32 formed at the rear end portion of the hammer arm 33, as depicted in FIG. 3 and FIG. 9.

In addition, the hammer fitting section 34 of the hammer arm 33 has been rotatably mounted on the hammer holding shaft 31 in this state. Accordingly, when the hammer member 11 rotates around the hammer holding shaft 31 in the clockwise direction, a moment of inertia occurs in the hammer member 11. A load by this moment of inertia is provided as an action load to the key 2 via the interlock control section 27 and the transmission member 10. As a result, a key-touch feel close to that of an acoustic piano can be acquired.

When the hammer member 11 displaces around the hammer holding shaft 31 in the clockwise direction as described above, the switch pressing section 39 of the hammer arm 33 presses the inverted-dome-shaped bulging section 42a of the rubber switch 42 provided to the switch substrate 40 from below, as depicted in FIG. 9. As a result, the inverted-dome-shaped bulging section 42a is elastically deformed and the plurality of movable contacts 42b in the bulging section 42a sequentially come into contact with the plurality of fixed contacts at time intervals.

Here, a switch signal corresponding to the depressed key 2 is supplied to the sound source section 40a, and musical sound data is generated therein. Subsequently, based on the generated musical sound data, a musical sound is emitted from a loudspeaker (not depicted) serving as a sound emitting section. Then, when the hammer member 11 further displaces around the hammer holding shaft 31 in the clockwise direction, the hammer arm 33 comes in contact with the upper-limit stopper 37 from below to regulate and stop the displacement of the hammer member 11.

Here, for example, when the hammer member 11 corresponding to a white key 2a displaces, the white-key stopper contact section 43a of the hammer arm 33 comes in contact with the upper-limit stopper 37 from below. When the hammer member 11 corresponding to a black key 2b displaces, the black-key stopper contact section 43b of the hammer arm 33 comes in contact with the upper-limit stopper 37 from below.

In this embodiment, the white-key stopper contact section 43a has been formed at a height substantially equal to the upper surface of the hammer arm 33, and the black-key stopper contact section 43b has been formed projecting from the upper surface of the hammer arm 33. Thus, even though the white key 2a and the black key 2b have different lengths in the front and rear direction and the length of the white key 2a is longer than the length of the black key 2b, the hammer member 11 corresponding to the white key 2a and the hammer member 11 corresponding to the black key 2b come in contact with the upper-limit stopper 37 with the same amount of displacement (displacement angle). Note that, as in a normal piano, the amount of displacement of the white key may be slightly larger than the amount of displacement of the black key.

Then, when a key release motion (returning motion) for returning the key 2 to its initial position is started, the transmission member 10 displaces in the clockwise direction by its self weight to return to its initial position with the interlock projecting section 28 being relatively movable with respect to the guide hole 29, and the hammer member 11 displaces in the counterclockwise direction by its self weight to return to its initial position. As a result, the key 2 returns to its initial position, and the interlock projecting section 28 of the interlock control section 27 comes in contact with or approaches the upper portion at the front end of the guide hole 29.

In the above-described keyboard device 1, when a key 2 is subjected to a key depression operation by a light force (weak force), this key 2 slowly displaces around the balance pins 4a and 4b in the clockwise direction and the capstan 26 of the key 2 slowly presses up the transmission member 10. Here, the weight of the transmission member 10 set by the shape and thickness of the vertical plate section 22a of the transmission body section 22 and the formation density of the plurality of rib sections 22b and 22c is provided to the key 2 as a static load.

As a result, the transmission member 10 slowly displaces against its self weight around the transmission holding shaft 21 of the transmission holding member 12 in the counterclockwise direction, and the interlock projecting section 28 of the interlock control section 27 slowly presses up the upper portion at the front end of the guide hole 29. Accordingly, the hammer member 11 slowly rotates around the hammer holding shaft 31 of the hammer holding member 13 in the clockwise direction to provide an action load to the key 2.

Then, the switch pressing section 39 of the hammer member 11 presses the rubber switch 42 provided to the switch substrate 40 and causes it to make a switching motion, whereby the upper portion at the rear end of the hammer member 11 comes in contact with the upper-limit stopper 37 from below and stops the displacement of the hammer member 11.

Here, a state is maintained in which the interlock projecting section 28 of the interlock control section 27 is in contact with the upper portion at the front end of the guide hole 29. In this state, when a key release motion (returning motion) for returning the key 2 to its initial position is started, the transmission member 10 displaces in the clockwise direction by its self weight and returns to the initial position with the interlock projecting section 28 of the interlock control section 27 being in contact with or positioned near the upper portion at the front end of the guide hole 29. In addition, the hammer member 11 displaces in the counterclockwise direction by its self weight and returns to the initial position. As a result, the key 2 returns to the initial position.

In the above-described keyboard device 1, when a key 2 is subjected to a key depression operation by a strong force, this key 2 quickly displaces around the balance pins 4a and 4b in the clockwise direction and the capstan 26 of the key 2 presses up the transmission member 10 at high speed. Here, acceleration occurs to the transmission body section 22 of the transmission member 10.

Accordingly, a dynamic load occurs in accordance with the weight set by the shape and thickness of the vertical plate section 22a of the transmission body section 22 and the formation density of the plurality of rib sections 22b and 22c and the barycenter position G set by the shape and thickness of the vertical plate section 22a and the formation positions of the plurality of rib sections 22b and 22c, and this dynamic load is provided to the key 2 and the hammer member 11.

As a result, the transmission member 10 rotates at high speed around the transmission holding shaft 21 of the transmission holding member 12 in the counterclockwise direction. Here, the interlock projecting section 28 of the interlock control section 27 abruptly presses up the upper portion at the front end of the guide hole 29. Accordingly, the hammer member 11 abruptly and quickly rotates around the hammer holding shaft 31 of the hammer holding member 13 in the clockwise direction and provides an action load to the key 2. Here, when the rotation speed of the hammer member 11 is higher than the rotation speed of the transmission member 10, the upper portion at the front end of the guide hole 29 of the interlock control section 27 moves away from the interlock projecting section 28, and the interlock projecting section 28 relatively moves inside the guide hole 29 toward its lower portion at the rear end.

Then, the switch pressing section 39 of the hammer member 11 abruptly presses the rubber switch 42 provided on the switch substrate 40 so that it makes a switching motion, and the upper portion at the rear end of the hammer member 11, that is, the white-key stopper contact section 43a or the black-key stopper contact section 43b abruptly comes in contact with the upper-limit stopper 37 from below. As a result, the hammer member 11 is bounced back by the upper-limit stopper 37.

Here, since the interlock projecting section 28 of the interlock control section 27 is relatively separated from the upper portion at the front end of the guide hole 29 as depicted in FIG. 9, the hammer member 11 rotates around the hammer holding shaft 31 in the counterclockwise direction, and the upper portion at the front end of the guide hole 29 of the interlock control section 27 comes in contact with or approaches the interlock projecting section 28. Accordingly, the hammer member 11 stops at a position away from the upper-limit stopper 37, or slightly rotates the transmission member 10 in the clockwise direction, whereby the bounce of the hammer member 11 is inhibited.

Then, when a key release motion (returning motion) for returning the key 2 to its initial position is started, the interlock projecting section 28 of the interlock control section 27 comes in contact with the upper portion at the front end of the guide hole 29 with it being movable along the guide hole 29. In this state, the transmission member 10 rotates in the clockwise direction by its self weight, and thereby returns to the initial position. In addition, the hammer member 11 rotates in the counterclockwise direction by its self weight, and thereby returns to the initial position. As a result, the key 2 returns to the initial position.

Also, in a so-called sequential depression operation of sequentially depressing one key 2 of the keyboard device 1, this key 2 is subjected to a key depression operation once, and then subjected to a key depression operation again while the hammer member 11, the transmission member 10, and the key 2 are returning to their initial positions after the hammer member 11 is pressed up and reaches the upper-limit position.

Here, the interlock projecting section 28 of the interlock control section 27 can move along the guide hole 29. Therefore, the hammer member 11 and the transmission member 10 make returning motions toward their initial positions by their own weights regardless of whether or not the rotation speed of the hammer member 11 in the returning direction and the rotation speed of the transmission member 10 in the returning direction are the same, and the key 2 also performs a returning motion along with it toward the initial position. Subsequently, when the key 2 is again subjected to a key depression operation in the course of its returning motion, the transmission member 10 in the course of returning to the initial position is again pressed up by the capstan 26 of the key 2.

Then, the transmission member 10 in the course of returning to the initial position rotates again around the transmission holding shaft 12 in the counterclockwise direction. Here, the interlock projecting section 28 of the interlock control section 27 moves along the guide hole 29, and presses up the upper portion at the front end of the guide hole 29. As a result, the hammer member 11 in the course of returning to the initial position rotates again around the hammer holding shaft 31 in the clockwise direction, provides an action load to the key 2, and presses the rubber switch 42 so that it makes a switching motion.

That is, for a sequential depression operation on one key 2, the retuning motion of the hammer member 11 and the returning motion of the transmission member 10 are controlled by a relative movement of the interlock projecting section 28 with respect to the guide hole 29 of the interlock control section 27. As a result, the sequential depression operation of sequentially depressing one key 2 can be favorably performed, whereby the sequential depression performance is improved.

As described above, the keyboard device 1 of the electronic keyboard instrument includes the plurality of transmission members 10 which is provided corresponding to the plurality of keys 2 and displaced in accordance with key depression operations on the plurality of keys 2 and the plurality of hammer members 11 which is provided corresponding to the plurality of keys 2 and each of which performs a rotating motion in accordance with the displacement of the transmission member 10 corresponding to a depressed key 2 so as to provide an action load to the depressed key 2. In addition, the weight of the transmission member 10 is set in accordance with the formation density of the plurality of rib sections 22b and 22c formed on the transmission body section 22. Therefore, a favorable key touch can be acquired with a simple structure.

That is, in the keyboard device 1 of the electronic keyboard instrument, the weight of the transmission member 10 can be set in accordance with the formation density of the plurality of rib sections 22b and 22c formed on the transmission body section 22. Therefore, this set weight of the transmission member 10 can be provided to the corresponding key 2 as a static load. As a result, an initial load on the key 2 can be optimized and a key depressing force on the key 2 at the time of key depression can be favorably transmitted to the hammer member 11 as a static load. Accordingly, a favorable key touch can be acquired with a simple structure.

Here, the transmission body section 22 is made of hard synthetic resin such as ABS resin and have the thin vertical plate section 22a, the plurality of rib sections 22b formed in an substantially lattice shape on the outer peripheral portion and both side surfaces of the vertical plate section 22a, and the plurality of fine-grid rib sections 22c further provided in part of the cells in the lattice. Therefore, the weight of the transmission member 10 can be set by the formation density of the plurality of rib sections 22b and 22c, and the transmission body section 22 can be easily manufactured by using a metal mold for molding.

Also, the keyboard device 1 of the electronic keyboard instrument includes the plurality of transmission members 10 which is provided corresponding to the plurality of keys 2 and displaced in accordance with key depression operations on the plurality of keys 2 and the plurality of hammer members 11 which is provided corresponding to the plurality of keys 2 and each of which performs a rotating motion in accordance with the displacement of the transmission member 10 corresponding to a depressed key so as to provide an action load to the depressed key 2. In addition, the barycenter position G of the transmission member 10 is set in accordance with the formation positions of the plurality of rib sections 22b and 22c formed on the transmission body section 22. Therefore, a favorable key touch can be acquired with a simple structure.

That is, in the keyboard device 1 of the electronic keyboard instrument, the barycenter position G of the transmission member 10 can be set in accordance with the formation positions of the plurality of rib sections 22b and 22c formed on the transmission body section 22. Therefore, when the transmission member 10 is displaced by the corresponding key 2 subjected to a key depression operation, an dynamic load can be provided to the key 2 by the barycenter position G of the transmission member 10 set in accordance with the formation positions of the plurality of rib sections 22b and 22c formed on the transmission body section 10. In addition, a key depressing force on a key 2 at the time of key depression can be favorably transmitted to the hammer member 11 as a dynamic load. As a result, a favorable key touch can be acquired with a simple structure.

Also, here, the transmission body section 22 is made of hard synthetic resin such as ABS resin and have the thin vertical plate section 22a, the plurality of rib sections 22b formed in an substantially lattice shape on the outer peripheral portion and both side surfaces of the vertical plate section 22a, and the plurality of fine-grid rib sections 22c further provided in part of the cells in the lattice. Therefore, the barycenter position G of the transmission member 10 can be set by the formation state of the plurality of rib sections 22b and 22c, that is, the formation positions of the plurality of fine rib sections 22c provided to part of the plurality of rib sections 22b, at a position shifted from the center of the transmission body section 22. In addition, the transmission body section 22 can be easily manufactured by using a metal mold for molding.

As described above, in the keyboard device 1 of the electronic keyboard instrument, the weight of the transmission member 10 can be set in accordance with the formation density of the plurality of rib sections 22b and 22c formed on the transmission body section 22, and the barycenter position G of the transmission member 10 can be set in accordance with the formation positions of the plurality of rib sections 22b and 22c formed on the transmission body section 22.

Accordingly, in the keyboard device 1, the set weight of the transmission member 10 can be provided to the corresponding key 2 as a static load, and a key depressing force on the key 2 at the time of key depression can be favorably transmitted to the hammer member 11 as a static load. Also, when the transmission member 10 is displaced by the corresponding key 2 subjected to a key depression operation, a dynamic load can be provided to the key 2 by the set barycenter position G of the transmission member 10. In addition, a key depressing force on a key 2 at the time of key depression can be favorably transmitted to the hammer member 11 as a dynamic load.

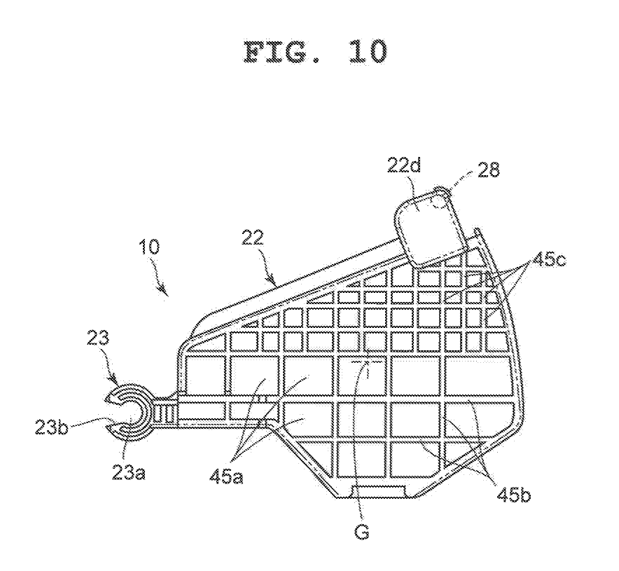

In the above-described embodiment, the transmission body section 22 is structured to have the plurality of rib sections 22b formed in an substantially lattice shape on both side surfaces of the thin vertical plate section 22a and the plurality of finer-grid rib sections 22c with an increased number of ribs formed in part of the cells in the lattice. However, the present invention is not limited to thereto, and may be structured as shown in a modification example depicted in FIG. 10.

That is, in the transmission body section 22 of the modification example, a plurality of rib sections 45b are formed having a large-grid lattice shapes on the lower side of the center on both side surfaces of a thin vertical plate section 45a, and a plurality of rib sections 45c is formed having a small-grid lattice shape with an increased number of ribs on the upper side of the center of both side surfaces of the vertical plate section 45a.

In this transmission body section 22, the weight of the transmission member 10 can be set in accordance with the formation density of the plurality of rib sections 45b and 45c. Therefore, the set weight of the transmission member 10 can be provided to the corresponding key 2 as a static load, and the barycenter position G of the transmission member 10 can be set at a position higher than that in the above-described embodiment in accordance with the formation positions of the plurality of rib sections 45b and 45c formed on the transmission body section 22. As a result of this structure, a dynamic load different from that of the above-described embodiment can be provided to a key 2.

Also, the present invention is not limited to the above structure, and the weight of the transmission member 10 may be set by changing the entire thickness of the vertical plate sections 22a and 45a of the transmission body section 22.

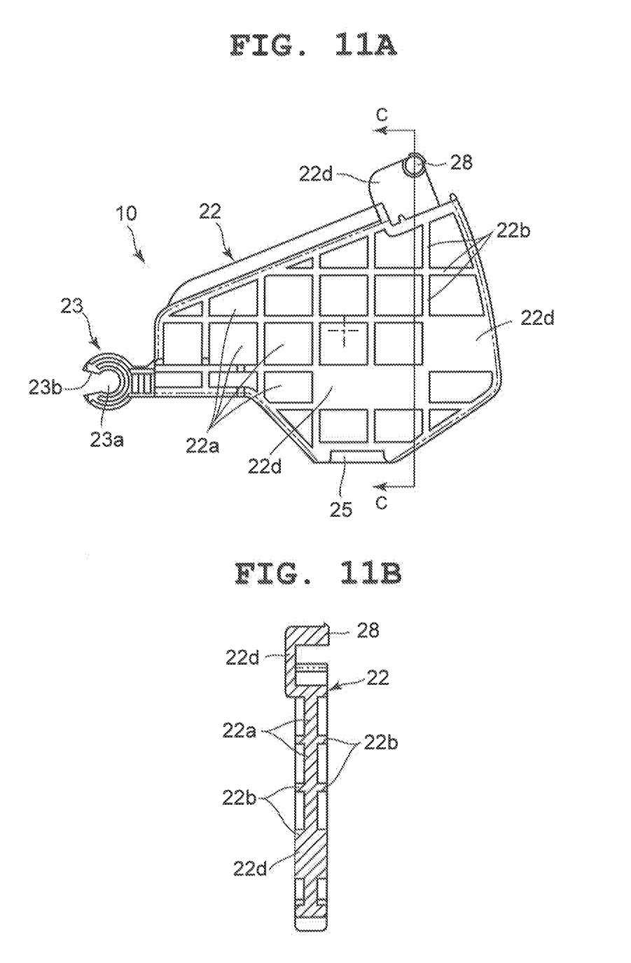

Also, instead of increasing the number of ribs formed in the cells, the weight and the barycenter position G of the transmission member 10 may be set by providing, in a cell whose weight is desired to be increased, a vertical plate section 22d thicker than the vertical plate section 22a in another cell as a barycenter position setting member of the present invention, as depicted in FIG. 11A and FIG. 11B. In addition, it is also possible to change the vertical plate section 22a in the cell whose weight is desired to be increased to a member made of a heavier-weight material.

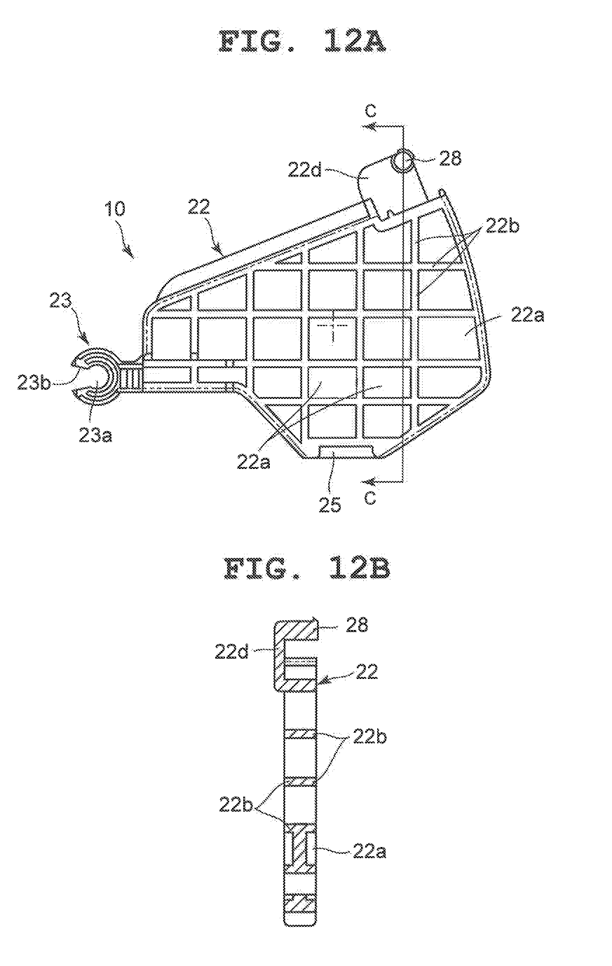

Moreover, a structure may be adopted in which the transmission body section 22 is formed of only the plurality of rib sections 22b formed in a lattice shape, and the vertical plate section 22a serving as a barycenter position setting member of the present invention is provided only in a cell whose weight is desired to be increased while no vertical plate section is provided in the other cells, as depicted in FIG. 12A and FIG. 12B.

Furthermore, in the present embodiment, the weight of the rib sections is increased by forming a plurality of finer-grid rib sections by increasing the number of ribs formed in part of the cells. However, instead of increasing the number of ribs to be formed, each rib may be thickened to increase the entire weight of the rib sections.

Still further, in the above-described embodiment, the interlock projecting section 28 of the interlock control section 27 is provided to the transmission member 10 and the guide hole 29 is provided in the hammer member 11. However, the present invention is not limited thereto. For example, a structure may be adopted in which the interlock projecting section 28 is provided to the guide mount section 33c of the hammer member 11 and the guide hole 29 is provided in the support section 22d of the transmission member 10.

In this structure, when a key 2 is depressed by a weak force, the hammer member 11 can be slowly pressed up and rotated with the interlock projecting section 28 of the hammer member 11 being in contact with the lower portion at the rear end of the guide hole 29. Also, when the key 2 is to return to the initial position, the transmission member 10 and the hammer member 11 can be each returned to the initial position with the interlock projecting section 28 of the hammer member 11 being in contact with the lower portion at the rear end of the guide hole 29.

Also, when a key 2 is depressed by a strong force, the lower portion at the rear end of the guide hole 29 of the transmission member 10 strongly comes in contact with and presses up the interlock projecting section 28 of the hammer member 11, whereby the hammer member 11 can be rotated strongly. Here, even though the hammer member 11 strongly comes in contact with and bounces off the upper-limit stopper 37, the interlock projecting section 28 can be moved along the guide hole 29.

Accordingly, with this interlock control section 27 as well, the interlock projecting section 28 of the hammer member 11 can be moved toward the lower portion at the rear end of the guide hole 29 of the transmission member 10 when the hammer member 11 rotates toward the initial position earlier than the transmission member 10. Therefore, the rotating motion of the hammer member 11 can be controlled by a relative motion of the interlock projecting section 28 with respect to the guide hole 29. Thus, an unnatural and unnecessary motion of the hammer member 11 can be inhibited, and therefore a key-touch feel close to that of an acoustic piano can be acquired, as with the above-described embodiment.

In addition, even in a sequential key depression operation of sequentially depressing one key 2, the returning motion of the hammer member 11 and the returning motion of the transmission member 10 can be controlled by a relative motion of the interlock projecting section 28 with respect to the guide hole 29 of the interlock control section 27. As a result, the sequential key depression operation of sequentially depressing one key 2 can be reliably and favorably performed, whereby the sequential key depression performance can be improved.

Moreover, in the above-described embodiment, a guide section for guiding the interlock projecting section 28 of the interlock control section 27 is the guide hole 29. However, the guide section is not necessarily the guide hole 29, and may be a guide groove section having a guide wall. In this case as well, the guide groove section is only required to be formed by being elongated along a relative motion path of the interlock projecting section 28.

Furthermore, in the above-described embodiment and the modification examples, the interlock projecting section 28 of the interlock control section 27 is provided to the support section 22d of the transmission member 10 or the mount section 33c of the hammer member 11 in a cantilever shape. However, the present invention is not limited thereto. For example, the interlock projecting section 28 may be provided in a both-end-support beam shape.

Still further, in the above-described embodiment, the transmission member is structured to perform a rotating motion. However, the present invention is not limited thereto. For example, a structure may be adopted in which a key depressing force is transmitted to the hammer member 11 by the vertical displacement (movement) of the transmission member in response to the key depression.

While the present invention has been described with reference to the preferred embodiments, it is intended that the invention be not limited by any of the details of the description therein but includes all the embodiments which fall within the scope of the appended claims.

What is claimed is:

1. A keyboard device comprising:
a plurality of keys; and
action mechanisms respectively provided corresponding to the plurality of keys,
wherein each of the action mechanisms includes a transmission member which is displaced in response to a depression operation on a corresponding key of the plurality of keys, a transmission holding shaft which holds the transmission member, and a hammer member which provides an action load to the corresponding key subjected to the depression operation by being displaced in a direction in response to the displacement of the transmission member corresponding to the key subjected to the depression operation,
wherein the transmission member includes a transmission body section, a transmission fitting section formed at one end of the transmission body section and mounted on the transmission holding shaft, and a barycenter position setting member formed on the transmission body section, and
wherein the barycenter position setting member is set so that a key touch feeling of the depression operation is adjusted.

2. The keyboard device according to claim 1, wherein the barycenter position setting member sets a barycenter position of the transmission member so that a distance between the barycenter position of the transmission member and a center position of the transmission fitting section is adjusted to a predefined value.

3. The keyboard device according to claim 1, wherein the transmission member includes a plurality of ribs formed on the transmission body section.

4. The keyboard device according to claim 3, wherein the plurality of ribs are formed in a lattice shape on the transmission body section, and the barycenter position setting member has ribs which form part of cells in a lattice formed of the plurality of ribs as a cell finer than a cell adjacent thereto.

5. The keyboard device according to claim 4, further comprising:
fine-grid ribs which forms a cell in the lattice as a cell finer than a cell adjacent thereto in accordance with a position of the transmission body section having a different distance from the transmission fitting section.

6. The keyboard device according to claim 5, wherein the fine-grid ribs are provided in two cells positioned on a lower side of center on the transmission body section and a cell positioned at a distance from the transmission fitting section longer than a distance from the center.

7. The keyboard device according to claim 5, wherein ribs formed on an upper side of the transmission body section are in a lattice shape finer than a lattice shape of ribs on a lower side of the transmission body section.

8. The keyboard device according to claim 1, wherein the transmission member has a vertical plate section and ribs formed in a lattice shape on the vertical plate section.

9. The keyboard device according to claim 8, wherein the barycenter position setting member is constituted by a vertical plate section surrounded by the ribs formed in the lattice shape and having a weight different from other portions, and the barycenter position of the transmission member is set by a position of the vertical plate section having the different weight on the transmission member.

10. The keyboard device according to claim 1, wherein the transmission member is constituted by ribs formed in a lattice shape.

11. The keyboard device according to claim 10, wherein the barycenter position setting member is constituted by a vertical plate section surrounded by the ribs formed in the lattice shape, and the barycenter position of the transmission member is set by a position of the vertical plate section provided on the transmission member.

12. A keyboard instrument comprising:
the keyboard device according to claim 1; and
a sound source section which emits a musical sound in response to an operation on a key of the keyboard device.
